(19) United States
(12) Patent Application Publication
(10) Pub. No.: US 2025/0066178 A1
(43) Pub. Date: Feb. 27, 2025

(54) CLEANING FLOW PATH AND WATER PURIFIER ASSEMBLY INCLUDING SAME

(71) Applicant: COWAY CO., LTD., Gongju-si (KR)

(72) Inventors: Sun Hyeok PARK, Seoul (KR); Hee Do JUNG, Seoul (KR); Jong Hwan LEE, Seoul (KR)

(73) Assignee: COWAY CO., LTD., Gongju-si (KR)

(21) Appl. No.: 18/721,301

(22) PCT Filed: Jan. 19, 2023
(86) PCT No.: PCT/KR2023/000897

§ 371 Date: Jun. 18, 2024

(30) Foreign Application Priority Data
Jan. 28, 2022 (KR) 10-2022-0013056

(51) Int. Cl. B67D 1/07; B67D 1/00; B67D 1/08

(52) U.S. Cl. CPC B67D 1/07; B67D 1/0014; B67D 1/08; B67D 2210/0001; B67D 2210/00031

(57) ABSTRACT

This cleaning flow path comprises: a case; and an escape prevention unit for preventing a cleaning agent accommodated in a dry state inside the case from escaping outside the case. The case includes: a body part that has an accommodation space for accommodating the cleaning agent therein; a water inlet passage that provides a flow path for water to flow into the accommodation space, is open toward the outside of the case, and can be installed into the water purifier by being connected to a first fastening hole in the water purifier connected to a raw water inlet port of a filter; and a water outlet passage that provides a flow path for the water accommodated in the accommodation space to flow out of the case, can be installed into the water purifier by being connected to a second fastening hole in the water purifier connected to a purified water outlet port of the filter, and is open in the same direction as the water inlet passage.

### TECHNICAL FIELD

The present disclosure relates to a cleaning flow path and a water purifier assembly including the same.

### BACKGROUND ART

In general, a water purifier is a device that receives water from a water source such as a tap, filters the water into purified water, and then provides the purified water to the user. Such a water purifier uses a filter to filter water into purified water, and the water filtered by the filter flows along the flow path provided inside the water purifier and then is discharged outside the water purifier.

Meanwhile, the purified water filtered through the filter may be provided directly to the user, but the purified water may also be cooled below a certain temperature and then provided as cold water, or heated above a certain temperature and then provided as hot water. In this case, the purified water filtered by the filter stays in the flow path or inside a tank for a certain period of time before being discharged to the outside of the water purifier.

However, when the water purifier described above is used for a long period of time, contaminants such as bacteria may be introduced in the water purifier, and the inside of the water purifier may be contaminated by these contaminants. In addition, when using a water purifier, oxidation/reduction reactions occur in a hot water unit that heats water due to hard substances, and lime scale formed as a result may block the flow path and a valve. In particular, in a case where the components such as the flow path and tank in addition to the filter are contaminated with contaminants, even though the water is filtered as clean purified water through the filter, the purified water may be re-contaminated by contaminants remaining in the flow path and tank while the water is discharged. Accordingly, a water treatment device that can sterilize the inside of a water purifier is being developed.

The present applicant's Korean Patent Application Publication No. 10-2017-0087842 entitled “Water treatment device capable of sterilization or cleaning and sterilization and cleaning method thereof” (Patent Document 1) discloses a water treatment device capable of sterilization or cleaning. An electrode sterilization module of Patent Document 1 is installed on a flow path connected to a storage tank when sterilization or cleaning of the storage tank is required, and can be separated after sterilization or cleaning is completed.

However, an electrode sterilization module of Patent Document 1 should be connected to the flow path of the water treatment device to be sterilized, and a separate connection tube or connector is needed to connect the electrode sterilization module to the flow path. In this case, the separate connection tube or connector should be additionally provided inside the water treatment device, which increases the volume and manufacturing cost.

Meanwhile, the electrode sterilization module of Patent Document 1 generates sterilizing washing water by electrolyzing water, and for this purpose, the electrode sterilization module includes an electrode device, an electrolyte supply unit, and a constant flow valve. However, in order to place the electrode device, electrolyte supply unit, and constant flow valve within the electrode sterilization module, the internal structure of the electrode sterilization module becomes complicated. Additionally, when the entire electrolyte supplied from the electrolyte supply unit is exhausted, it is difficult to reuse the electrode sterilization module by separately filling only the electrolyte in the electrolyte supply unit.

Therefore, there is a need for a cleaning kit having a structure that does not require additional separate components inside the water purifier and can be easily filled with a cleaning agent to be reused.

### PRIOR ART DOCUMENT

(Patent Document 1) Korean Patent Application Publication 10-2017-0087842 (2017.07.31)

### DETAILED DESCRIPTION OF INVENTION

### Technical Problems

One embodiment of the present disclosure is conceived in view of the above background, and provides a cleaning kit with a structure that does not require additional separate components inside the water purifier.

Further, one embodiment of the present disclosure provides a cleaning kit that can be easily filled with a cleaning agent and reused.

In addition, one embodiment of the present disclosure provides a cleaning kit that can reduce manufacturing costs through a simple structure.

### Technical Solution

In accordance with one embodiment of the present disclosure, a cleaning flow path comprising: a case configured to accommodate a cleaning agent therein; and an escape preventing unit configured to prevent the cleaning agent accommodated in a dry state inside the case from escaping outside the case, wherein the case includes a body portion having an accommodation space formed to accommodate the cleaning agent therein, a water inlet passage providing a flow path for water to flow into the accommodation space, opening toward the outside of the case, configured to be and installed at a water purifier by being connected to a first fastening hole of the water purifier at which connected to a raw water inlet port of a filter is connected, and a water outlet passage providing a flow path for the water accommodated in the accommodation space to flow out of the case, configured to be installed at the water purifier by being connected to a second fastening hole of the water purifier at which a purified water outlet port of the filter is connected, and opening in the same direction as the water inlet passage.

Further, the water inlet passage may include a first water inlet passage end portion connected to the body portion to communicate with the accommodation space, the water outlet passage may include a first water outlet passage end portion connected to the body portion to communicate with the accommodation space, and the escape preventing unit may include a plurality of escape preventing members disposed at the first water inlet passage end portion and the first water outlet passage end portion.

Further, the body portion may include a first body portion and a second body portion that are separably coupled to each other, an engagement portion may be formed in the first body portion, and a fixture, which may engage the engagement portion when the first body portion and the second body portion are coupled, may be formed on the second body portion.

Further, the first body portion may have a greater width than that of the second body portion in a width direction of the case, and the cleaning flow path may further include a sealing member configured to seal between the first body portion and the second body portion in the width direction when the first body portion and the second body portion are coupled.

Further, the escape preventing unit may have a mesh structure to prevent the solid cleaning agent from escaping while allowing the water to flow.

Further, the water inlet passage and the water outlet passage may have a separation distance equal to a separation distance between the first fastening hole and the second fastening hole.

Further, the cleaning flow path may have a size to be accommodated in a filter insertion port of the water purifier.

Further, a water purifier assembly may comprise: a water purifier including a first fastening hole and a second fastening hole; a filter configured to filter water to provide purified water and including a raw water inlet port connected to the first fastening hole and a purified water outlet port connected to the second fastening hole; and a cleaning flow path configured to clean the water purifier and detachably installed in the water purifier, wherein the cleaning flow path includes a case configured to accommodate a cleaning agent therein; and an escape preventing unit configured to prevent the cleaning agent accommodated in a dry state inside the case from escaping outside the case, and wherein the case includes: a body portion having an accommodation space formed to accommodate the cleaning agent therein, a water inlet passage providing a flow path for water to flow into the accommodation space, opening toward the outside of the case, and configured to be installed at the water purifier by being connected tothe first fastening hole, and a water outlet passage providing a flow path for the water accommodated in the accommodation space to flow out of the case, configured to be installed at the water purifier by being connected to the second fastening hole, and opening in the same direction as the water inlet passage.

### Effect of Invention

According to one embodiment of the present disclosure, there is no need to additionally provide a separate connection tube or connector inside the water purifier.

In addition, according to one embodiment of the present disclosure, the cleaning kit can be reused by easily filling the inside with a cleaning agent.

Additionally, according to one embodiment of the present disclosure, manufacturing costs can be reduced through a simple structure.

### BRIEF DESCRIPTION OF THE DRAWING

FIG. 1 is a view illustrating a cleaning kit according to one embodiment of the present disclosure separated from a water purifier.

FIG. 2 is a perspective view of the cleaning kit of FIG. 1.

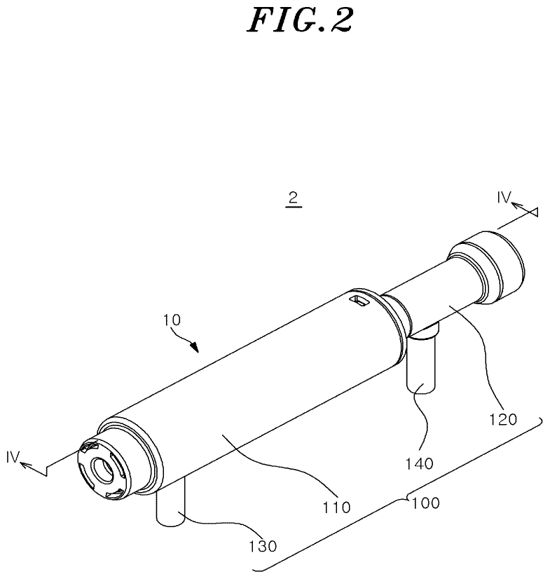

FIG. 3 is an exploded perspective view of the cleaning kit of FIG. 2.

FIG. 4 is a cross-sectional view taken along line IV-IV of FIG. 2.

FIG. 5 is a rear view of the water purifier of FIG. 1.

FIG. 6 is a view illustrating a filter separated from the water purifier of FIG. 1.

### BEST MODE FOR CARRYING OUT THE INVENTION

Hereinafter, specific embodiments for implementing the technical idea of the present disclosure will be described in detail with reference to the drawings.

In addition, when describing the present disclosure, when it is determined that a detailed description of a related known configuration or function may obscure the gist of the present disclosure, the detailed description will be omitted.

In addition, when a component is mentioned as being “connected”, “introduced”, “discharged”, “flowed”, or “combined” with another component, the component may be directly connected, introduced, discharged, flowed, or combined with the other component, but it should be understood that other components may exist in the middle.

The terms used herein are merely used to describe specific embodiments and are not intended to limit the disclosure. Singular expressions include plural expressions unless the context clearly dictates otherwise.

Additionally, terms including ordinal numbers, such as first, second, or the like may be used to describe various components, but the components are not limited by these terms. These terms are used only to distinguish one component from another.

As used in the specification, the meaning of “including” is to specify a specific characteristic, area, integer, step, operation, element and/or component, and does not exclude the existence or addition of another specific property, area, integer, step, operation, element, component and/or group.

Hereinafter, the specific configuration of the water purifier assembly 1 according to one embodiment of the present disclosure will be described with reference to the drawings.

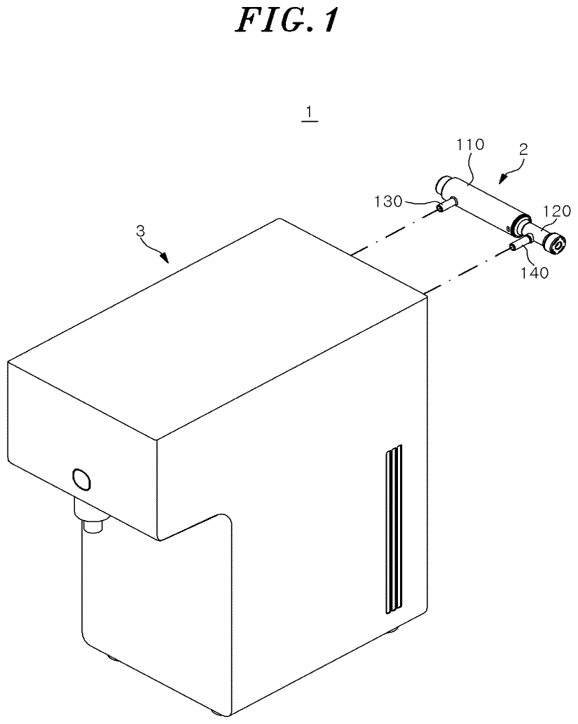

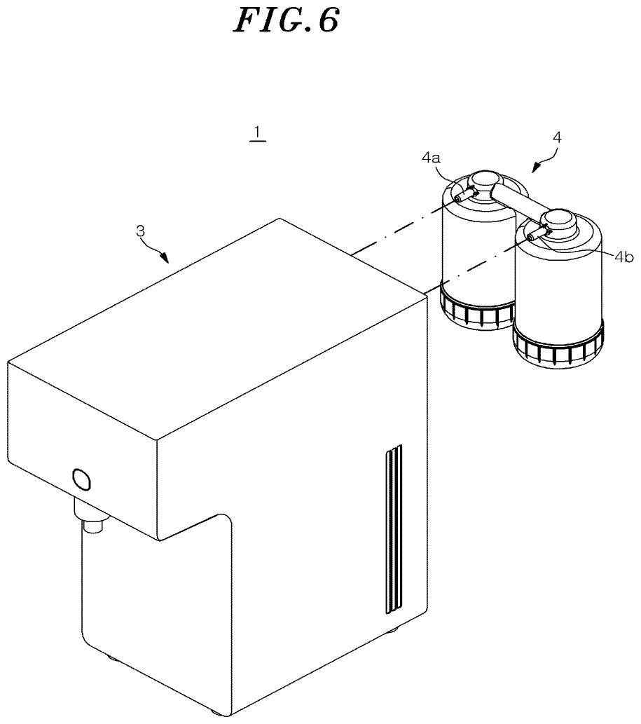

Referring to FIGS. 1 and 6, the water purifier assembly 1 may filter water and provide purified water to a user. The water purifier assembly 1 may include a cleaning kit 2, a water purifier 3, and a filter 4.

Hereinafter, the cleaning kit 2 according to one embodiment of the present disclosure may be used to sterilize and clean the inside of the water purifier 3. The cleaning kit 2 may be installed in a replaceable manner inside the water purifier 3 to sterilize and clean the inside of the water purifier 3. For example, when water flows into the cleaning kit 2 while the cleaning kit 2 is mounted on the water purifier 3, a cleaning solution is formed in the cleaning kit 2, and the cleaning solution flows into the water purifier 3 to sterilize and clean the water purifier 3. The cleaning kit 2 may include a cleaning flow path 10 and a cleaning agent 20.

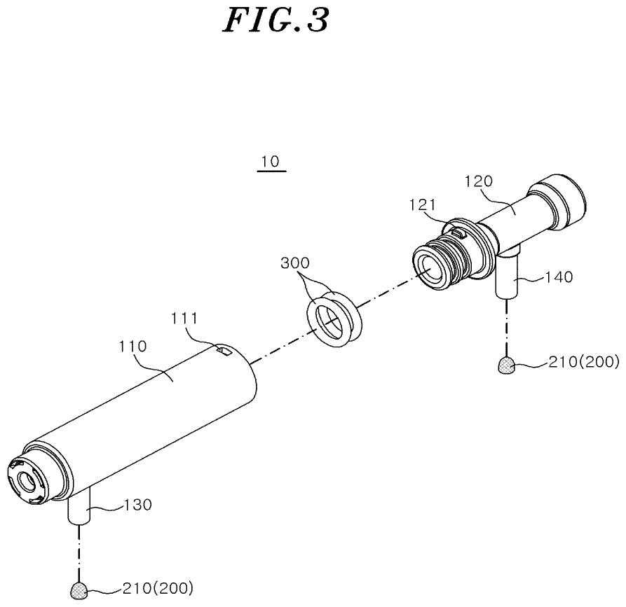

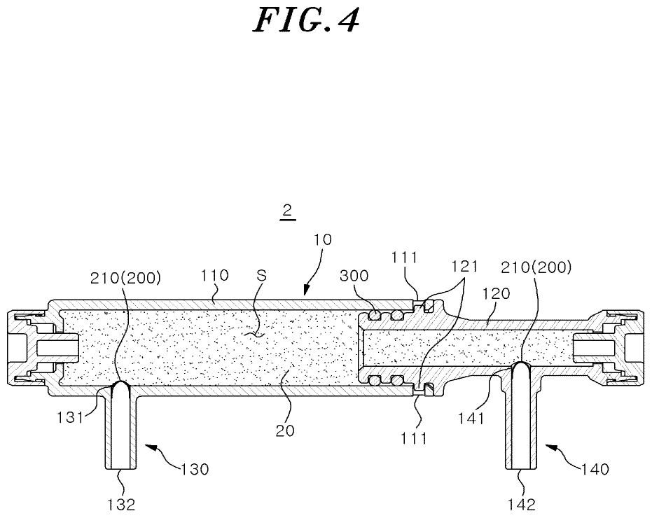

Referring to FIGS. 3 and 4, the cleaning flow path 10 may accommodate the cleaning agent 20 therein and may provide a passage for water to flow. The cleaning flow path 10 may be attached to and detached from the water purifier 3. For example, the cleaning flow path 10 can be installed in the position of the filter 4 after the filter 4 is separated from the water purifier 3. In addition, the cleaning flow path 10 may have a size that can be accommodated in a filter insertion port 3c, which will be described later, of the water purifier 3. The cleaning flow path 10 may include a case 100, an escape preventing unit 200, and a sealing member 300.

The case 100 may accommodate the cleaning agent 20 therein and may have a certain level of rigidity. The case 100 may include body portions 110 and 120, a water inlet passage 130, and a water outlet passage 140.

An accommodation space S may be formed inside the body portions 110 and 120 to accommodate the cleaning agent 20. Water flows into the body portions 110 and 120 through the water inlet passage 130, and the water flowing into the body portions 110 and 120 may be discharged to the outside of the body portions 110 and 120 through the water outlet passage 140. Moreover, the body portions 110 and 120 may provide a space in which the cleaning solution is formed. For example, when water flows into the body portions 110 and 120, the introduced water is mixed with the cleaning agent 20 accommodated in the accommodation space S. In this case, the cleaning liquid may be formed inside the body portions 110 and 120. In the present specification, the cleaning solution may refer to a mixed solution in which the cleaning agent 20 is mixed with water. These body portions 110 and 120 may include a first body portion 110 and a second body portion 120.

The first body portion 110 and the second body portion 120 may be separably coupled to each other. For example, the first body portion 110 may be coupled to the second body portion 120 or separated from the second body portion 120 by rotating with respect to the second body portion 120. When the first body portion 110 and the second body portion 120 are coupled to each other, the accommodation space S may be provided. In addition, the first body portion 110 and the second body portion 120 may have a cylindrical shape, and the first body portion 110 may have a width larger than that of the second body portion 120. In this case, the second body portion 120 may be coupled to the first body portion 110 while being inserted inside the first body portion 110. Here, the widths of the first body portion 110 and the second body portion 120 may mean the diameters of the first body portion 110 and the second body portion 120, and as an example, may mean a vertical width in FIG. 4.

Meanwhile, referring again to FIG. 3, an engagement portion 111 may be formed in the first body portion 110, and a fixture 121 may be formed in the second body portion 120. The engagement portion 111 may engage the fixture 121 when the first body portion 110 and the second body portion 120 are coupled. In this case, the coupling of the first body portion 110 and the second body portion 120 can be maintained. In addition, when the engagement between the engagement portion 111 and the fixture 121 is released, the first body portion 110 may be separated from the second body portion 120. For example, the engagement portion 111 may have the shape of a protrusion, and the second body portion 120 may have the shape of a hole. However, this is only an example, and the engagement portion 111 may have the shape of a hole, and the fixture 121 may have the shape of a protrusion.

Referring again to FIG. 4, the water inlet passage 130 may provide a flow path for water to flow into the accommodation space S. For example, when the cleaning kit 2 is mounted on the water purifier 3, the water supplied from the water purifier 3 flows into the accommodation space S through the water inlet passage 130. In addition, the water inlet passage 130 may protrude from the body portions 110 and 120 in one direction and may be open to the outside of the case 100. The water inlet passage 130 may include a first water inlet passage end portion 131 and a second water inlet passage end portion 132.

The first water inlet passage end portion 131 may be connected to the body portions 110 and 120 to communicate with the accommodation space S. The first water inlet passage end portion 131 may be an end portion connected to the body portions 110 and 120 of both end portions of the water inlet passage 130.

The second water inlet passage end portion 132 may be open toward the outside of the case 100 to communicate with the outside of the case 100. The second water inlet passage end portion 132 may be an end portion formed on a side opposite to the first water inlet passage end portion 131 of both end portions of the water inlet passage 130. For example, the second water inlet passage end portion 132 may be connected to the water purifier 3 when the cleaning kit 2 is mounted on the water purifier 3.

The water outlet passage 140 may provide a flow path for water contained in the accommodation space S to flow to the outside of the case 100. For example, in a case where the cleaning kit 2 is mounted on the water purifier 3, when water flows into the accommodation space S, a cleaning solution is formed, and the cleaning solution may flow into the water purifier 3 through the water outlet passage 140. The water outlet passage 140 may protrude from the body portions 110 and 120 in the same direction as the water inlet passage 130. In addition, the water outlet passage 140 is open toward the outside of the case 100 and may be open toward the same direction as the water inlet passage 130. The water outlet passage 140 may include a first water outlet passage end portion 141 and a second water outlet passage end portion 142.

The first water outlet passage end portion 141 may be connected to the body portions 110 and 120 to communicate with the accommodation space S. The first water outlet passage end portion 141 may be an end portion connected to the body portions 110 and 120 of both end portions of the water outlet passage 140.

The second water outlet passage end portion 142 may be open toward the outside of the case 100 to communicate with the outside of the case 100. The second water outlet passage end portion 142 may be an end portion formed on a side opposite to the first water outlet passage end portion 141 of both end portions of the water outlet passage 140. For example, the second water outlet passage end portion 142 may be connected to the water purifier 3 when the cleaning kit 2 is mounted on the water purifier 3.

Meanwhile, the water inlet passage 130 and the water outlet passage 140 may have shapes and sizes corresponding to a raw water inlet port 4a and a purified water outlet port 4b of the filter 4, which will be described later, respectively. In addition, the water inlet passage 130 and the water outlet passage 140 may have a separation distance equal to a separation distance between a first fastening hole 3a and a second fastening hole 3b, which will be described later.

The escape preventing unit 200 can prevent the cleaning agent 20 accommodated inside the case 100 from escaping to the outside of the case 100. The escape preventing unit 200 may include a plurality of escape preventing members 210.

The plurality of escape preventing members 210 can prevent the cleaning agent 20 accommodated in the accommodation space S from escaping through the water inlet passage 130 or the water outlet passage 140. For example, the plurality of escape preventing members 210 may be disposed in the first water inlet passage end portion 131 and the first water outlet passage end portion 141.

For example, the escape preventing member 210 may have a mesh structure to prevent the solid cleaning agent 20 from escaping while allowing water to flow. In this case, the escape preventing member 210 allows the flow of water flowing into the accommodation space S through the water inlet passage 130 and the flow of water from the accommodation space S to the water outlet passage 140. In addition, the escape preventing member 210 prevents the cleaning agent 20 placed in the accommodation space S from escaping from the accommodation space S without being mixed with water.

The sealing member 300 can prevent water from leaking between the first body portion 110 and the second body portion 120 when the first body portion 110 and the second body portion 120 are combined. In other words, the sealing member 300 may seal between the first body portion 110 and the second body portion 120. For example, the sealing member 300 may be provided as an O-ring, and the O-ring may be provided between the first body portion 110 and the second body portion 120 in a width direction. In this case, the sealing member 300 may be disposed between an inner peripheral surface of the first body portion 110 and an outer peripheral surface of the second body portion 120. Here, the width direction may be an up-down direction of FIG. 4.

The cleaning agent 20 can be accommodated within the cleaning flow path 10. The cleaning agent 20 is a substance that has sterilizing and cleaning functions, and may include citric acid as an example. In addition, the cleaning agent 20 may be provided as a solid when in a dry state, or may be a compressed powder. For example, when water flows into the cleaning flow path 10, the cleaning agent 20 in a dry state is mixed with water inside the cleaning flow path 10. In this case, a cleaning liquid is formed by mixing the cleaning agent 20 and water, and the cleaning liquid flows into the water purifier 3 to sterilize and clean an internal flow path and a tank of the water purifier 3.

Meanwhile, the cleaning agent 20 may be provided to occupy a predetermined volume within the accommodation space S. For example, the cleaning agent 20 may be accommodated inside the case 100 so that a volume of the cleaning agent is 95% to 99.9% of a volume of the accommodation space S. The cleaning agent 20 can be accommodated inside the case 100 without escaping to the outside of the case 100 due to the escape preventing unit 200.

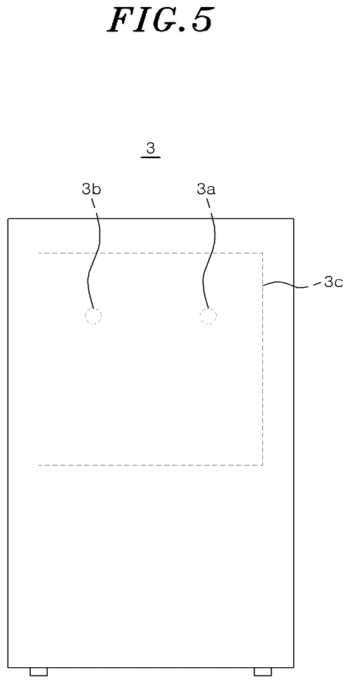

Referring to FIG. 5, the cleaning kit 2 and the filter 4 may be installed in a replaceable manner in the water purifier 3. This water purifier 3 may include the first fastening hole 3a and the second fastening hole 3b connected to the cleaning kit 2 and the filter 4. In addition, the water purifier 3 may include the filter insertion port 3c into which the filter 4 is inserted.

The first fastening hole 3a and the second fastening hole 3b may be arranged to be spaced a predetermined distance apart from each other. The water inlet passage 130 of the cleaning kit 2 may be connected to the first fastening hole 3a, and the raw water inlet port 4a of the filter 4 can be connected to the first fastening hole. In addition, the water outlet passage 140 of the cleaning kit 2 may be connected to the second fastening hole 3b, and the purified water outlet port 4b of the filter 4 may be connected to the second fastening hole 3b.

The filter insertion port 3c may provide a space where the filter 4 is placed when the filter 4 is combined with the water purifier 3. The filter 4 may be inserted into the filter insertion port 3c. In addition, the filter insertion port 3c may accommodate the cleaning kit 2 when the cleaning kit 2 is combined with the water purifier 3.

Referring to FIG. 6, the filter 4 can be coupled to the water purifier 3 and may provide puriied water by filtering raw water. The filter 4 may include the raw water inlet port 4a through which raw water is received from the water purifier 3 and the purified water outlet port 4b through which filtered purified water is discharged to the water purifier 3. These raw water inlet ports 4a and purified water outlet ports 4b may have a separation distance equal to the separation distance between the water inlet passage 130 and the water outlet passage 140.

Hereinafter, the operation and effects of the cleaning kit 2 having the above-described configuration will be described.

Referring to FIGS. 1 and 6, the cleaning kit 2 can be installed inside the water purifier 3 to sterilize and clean the inside of the water purifier 3. The user may separate the filter 4 from the water purifier 3 and then install the cleaning kit 2 on the part where the filter 4 is installed. For example, when the filter 4 is separated from the water purifier 3, the raw water inlet port 4a and purified water outlet port 4b of the filter 4 are separated from the first fastening hole 3a and the second fastening hole 3b of the water purifier 3, respectively. In this case, when the cleaning kit 2 is mounted on the water purifier 3, the water inlet passage 130 and the water outlet passage 140 are connected to the first fastening hole 3a and the second fastening hole 3b of the water purifier 3, respectively.

In a case where the cleaning kit 2 is mounted on the water purifier 3, when water flows inside the water purifier 3, the water flows through the first fastening hole 3a and the water inlet passage 130 into the body portions 110 and 120. In this case, the water flowing into the accommodation space S is mixed with the cleaning agent 20 to form the cleaning solution, and the cleaning solution flows back into the water purifier 3 through the water outlet passage 140 and the second fastening hole 3b. The cleaning solution flowing into the water purifier 3 may sterilize and clean contaminants while flowing along the flow path and tank inside the water purifier 3.

In this way, since the cleaning kit 2 according to one embodiment of the present disclosure is connected to the first fastening hole 3a and the second fastening hole 3b at which the filter 4 is installed in the water purifier 3, there is no need for a separate connector in the water purifier 3. Accordingly, there is an effect that the existing water purifier 3 can be used universally without changing the structure of the water purifier 3.

In addition, the cleaning kit 2 has the water inlet passage 130 and the water outlet passage 140 opening in the same direction so that the user can install the cleaning kit 2 on the water purifier 3 by simply pushing the cleaning kit in one direction. In addition, the cleaning kit 2 can be separated from the water purifier 3 by pulling the cleaning kit 2 in the other direction opposite to one direction. In other words, the user can simply attach the cleaning kit 2 to the water purifier and detach the cleaning kit from the water purifier.

In addition, the cleaning kit 2 is configured so that the first body portion 110 and the second body portion 120 are separable. Accordingly, even when the cleaning agent 20 is exhausted, the cleaning kit 2 can be used by filling the body portions 110 and 120 with the cleaning agent 20. Therefore, there is an effect in that the case 100 can be recycled without discarding the cleaning kit 2 in which the cleaning agent 20 has been completely exhausted.

Meanwhile, the structure of the cleaning kit 2 can be simplified by filling only the cleaning agent 20 without having devices and valves inside the cleaning kit 2, which reduces manufacturing costs and simplifies the process.

Although embodiments of the present disclosure have been described above as the specific embodiment, this is merely an example, and the present disclosure is not limited thereto, and should be construed as having the widest scope following the technical idea disclosed in this specification. A person skilled in the art may implement a pattern of a shape not specified by combining/substituting the disclosed embodiments, but this also does not depart from the scope of the present disclosure. In addition, a person skilled in the art can easily change or modify the embodiments disclosed based on the present specification, and it is clear that such changes or modifications also fall within the scope of the present disclosure.

What is claimed is:

1. A cleaning flow path comprising:
a case configured to accommodate a cleaning agent therein; and
an escape preventing unit configured to prevent the cleaning agent accommodated in a dry state inside the case from escaping outside the case,
wherein the case includes
a body portion having an accommodation space formed to accommodate the cleaning agent therein,
a water inlet passage providing a flow path for water to flow into the accommodation space, opening toward the outside of the case, and configured to be installed at a water purifier by being connected to a first fastening hole of the water purifier at which a raw water inlet port of a filter is connected, and
a water outlet passage providing a flow path for the water accommodated in the accommodation space to flow out of the case, configured to be installed at the water purifier by being connected to a second fastening hole of the water purifier at which a purified water outlet port of the filter is connected, and opening in the same direction as the water inlet passage.

2. The cleaning flow path of claim 1, wherein the water inlet passage includes a first water inlet passage end portion connected to the body portion to communicate with the accommodation space,
the water outlet passage includes a first water outlet passage end portion connected to the body portion to communicate with the accommodation space, and
the escape preventing unit includes a plurality of escape preventing members disposed at the first water inlet passage end portion and the first water outlet passage end portion.

3. The cleaning flow path of claim 1, wherein the body portion includes a first body portion and a second body portion that are separably coupled to each other,
an engagement portion is formed in the first body portion, and
a fixture, which engages the engagement portion when the first body portion and the second body portion are coupled, is formed on the second body portion.

4. The cleaning flow path of claim 3, wherein the first body portion has a greater width than that of the second body portion in a width direction of the case, and
the cleaning flow path further includes a sealing member configured to seal between the first body portion and the second body portion in the width direction when the first body portion and the second body portion are coupled.

5. The cleaning flow path of claim 1, wherein the escape preventing unit has a mesh structure to prevent the solid cleaning agent from escaping while allowing the water to flow.

6. The cleaning flow path of claim 1, wherein the water inlet passage and the water outlet passage have a separation distance equal to a separation distance between the first fastening hole and the second fastening hole.

7. The cleaning flow path of claim 1, wherein the cleaning flow path has a size to be accommodated in a filter insertion port of the water purifier.

8. A water purifier assembly comprising:
a water purifier including a first fastening hole and a second fastening hole;
a filter configured to filter water to provide purified water and including a raw water inlet port connected to the first fastening hole and a purified water outlet port connected to the second fastening hole; and
a cleaning flow path configured to clean the water purifier and detachably installed in the water purifier,
wherein the cleaning flow path includes:
a case configured to accommodate a cleaning agent therein; and
an escape preventing unit configured to prevent the cleaning agent accommodated in a dry state inside the case from escaping outside the case, and
wherein the case includes:
a body portion having an accommodation space formed to accommodate the cleaning agent therein,
a water inlet passage providing a flow path for water to flow into the accommodation space, opening toward the outside of the case, and configured to be installed at the water purifier by being connected to the first fastening hole, and
a water outlet passage providing a flow path for the water accommodated in the accommodation space to flow out of the case, configured to be installed at the water purifier by being connected to the second fastening hole, and opening in the same direction as the water inlet passage.
